(19) United States
(12) Patent Application Publication
(10) Pub. No.: US 2023/0210717 A1
(43) Pub. Date: Jul. 6, 2023

(54) STIMULATION DEVICE

(71) Applicant: EIS GmbH, Bielefeld (DE)

(72) Inventor: Florian M. WITT, Wentorf (DE)

(73) Assignee: EIS GmbH, Bielefeld (DE)

(21) Appl. No.: 18/000,966

(22) PCT Filed: Jun. 9, 2021
(86) PCT No.: PCT/EP2021/065526

§ 371 Date: Dec. 7, 2022

(30) Foreign Application Priority Data
Jun. 9, 2020 (DE) 10 2020 115 262.0

(51) Int. Cl. A61H 19/00; A61H 9/00

(52) U.S. Cl. CPC A61H 19/30; A61H 9/0071; A61H 2201/0153

(57) ABSTRACT

A stimulation device for stimulating sensitive body parts, in particular the clitoris, with a pressure field generating device which has at least one cavity with a first end and a second end, wherein the cavity is delimited by a circumferential side wall connecting its two ends to one another and the first end of the cavity is provided with an application opening for placement on the sensitive body part, and a drive device which is designed to cause a change in the volume of the cavity such that a stimulating pressure field is generated in the application opening. The side wall in at least one section has an essentially continuously circumferential structure, which is variable in length in such a way that the distance at any given point between the second end and the first end of the cavity is variable between a minimum a maximum value.

The invention relates to a stimulation device for stimulating sensitive body parts, in particular the clitoris, with a pressure field generating device which has at least one cavity with a first end and a second end remote from the first end, wherein the cavity is delimited by a circumferential side wall connecting its two ends to one another and the first end is provided with an application opening for placement on the sensitive body part, and a drive device which is designed to cause a change in the volume of the cavity such that a stimulating pressure field is generated in the application opening, wherein the cavity is closed on its second end, which is moved by the drive device alternately in the direction of the application opening and in the direction opposite thereto.

A device of the type mentioned above is known, for example, from EP 3 228 297 A1. In this known device, the second end of the cavity is closed with a membrane which is moved by the drive device alternately in the direction of the application opening formed in the first end of the cavity and in the direction opposite thereto. The reciprocal movement of the membrane causes a change in the volume of the antechamber, whereby a stimulating pressure field is generated in the application opening at the first end of the cavity. For the most efficient operation possible, the membrane is acted upon by the drive device with a reciprocal movement essentially at a right angle to the longitudinal extension of the membrane. During its reciprocal movement, the membrane undergoes deflection or deformation alternately toward and away from the second end of the cavity. Even if the use of a membrane has so far proven itself in practice, it has become apparent during the development of some new devices that the use of conventional membranes can reach their limits with regard to the design and function thereof. For example, conventional membranes cannot be bent arbitrarily. Rather, due to the design, the degree of deflection or deformation is limited, which then also limits the maximum amount of volume change and thus the maximum possible amplitude of the pressure waves of the stimulating pressure field resulting therefrom. Furthermore, existing spatial and/or design limitations with some new developments cause problems in the implementation of a conventional membrane.

It is an object of the present invention to improve a stimulation device of the type mentioned above compared to the prior art in such a way that the definition of the maximum amount of the volume change and thus the maximum amplitude of the pressure waves are not subject to any significant restrictions.

In particular, it is an object of the present invention to propose a stimulation device of the type mentioned with a design which is an alternative to the prior art and, at the same time, is simple and effective and which is not subject to the design and/or functional limitations present in the implementation of a conventional membrane.

These objects are achieved with a stimulation device for stimulating sensitive body parts, in particular the clitoris, with a pressure field generating device which has at least one cavity with a first end and a second end remote from the first end, wherein the cavity is delimited by a circumferential side wall connecting its two ends to one another and the first end is provided with an application opening for placement on the sensitive body part, and a drive device which is designed to cause a change in the volume of the cavity such that a stimulating pressure field is generated in the application opening, wherein the cavity is closed on its second end, which is moved by the drive device alternately in the direction of the application opening and in the direction opposite thereto, characterized in that the side wall in at least one section has a continuously circumferential structure, which is designed to be variable in length in such a way that the distance at any given point between the second end and the first end of the cavity can be changed between a minimum value and a maximum value.

With the help of the invention, the design measure responsible for the change in volume is shifted to the circumferential side wall delimiting the cavity and is implemented there in the form of an essentially continuously circumferential structure, which is designed to be variable in length in such a way that the distance at any given point between the second end and the first end of the cavity can be changed between a minimum value and a maximum value. The essentially continuously circumferential structure implemented in the side wall at least in sections ensures the desired change in volume for generating a stimulating pressure field in the application opening due to the fact that it is variable in length according to the invention. The length-variable structure in the side wall is not subject to any significant design restrictions, so that the desired maximum amount of volume change and thus the desired maximum amplitude of the pressure waves of the stimulating pressure field resulting therefrom can be realized without significant limitations. This is because the more variable the length of the structure, the higher the maximum volume change. In this context, it should also be noted that although the side wall delimits the cavity, it is also part of the cavity. The fact that the structure according to the invention is designed to be variable in length in such a way that the distance at any given point between the second end and the first end of the cavity can be changed between a minimum value and a maximum value means, on the one hand, that the distance at any given point between the second end and the first end of the cavity does not change during the change in length of the structure and thus remains constant, and, on the other hand, that the distance at any given point between the second end and the first end of the cavity is not necessarily changed in the same way.

Preferred refinements of the invention are specified in the dependent claims.

Preferably, the side wall with its circumferential, length-variable structure is designed in such a way that the shape of the side wall remains essentially unchanged, apart from an elongation when the distance between the second end and the first end of the cavity changes from the minimum value to the maximum value and a compression when the distance between the second end and the first end changes from the maximum value to the minimum value. In this embodiment, the shape of the side wall with the length-variable structure inserted therein remains fundamentally recognizable during the change in length of the structure according to the invention, wherein only a change in the relative proportions results from the change in length.

In a structurally especially simple, preferred embodiment, essentially the entire side wall is formed by the circumferential, length-variable structure.

In an alternative preferred embodiment, the circumferential, length-variable structure is arranged at a distance from the first end of the cavity, and the side wall has a substantially pressure-resistant and tensile-resistant, preferably rigid, section between the circumferential, length-variable structure and the first end of the cavity. In this embodiment, the reciprocating motion generated by the drive device is transmitted to the length-variable structure via the second end of the cavity either directly or through the section of the side wall of the cavity between the length-variable structure and the second end.

In a preferred alternative embodiment, the circumferential, length-variable structure is arranged at a distance from the second end of the cavity, and the side wall has a substantially pressure-resistant and tensile-resistant, preferably rigid, section between the circumferential, length-variable structure and the second end of the cavity. In this embodiment, the reciprocating motion generated by the drive device is transmitted from the second end of the cavity to the length-variable structure via said section.

In a further preferred alternative embodiment, the circumferential length-variable structure is arranged adjacent to the second end of the cavity or is adjacent to the second end of the cavity. In this embodiment, the reciprocating motion generated by the drive device is transmitted from the second end of the cavity to the length-variable structure essentially directly.

Preferably, the circumferential, length-variable structure has a wall that can be expanded, at least in sections, in the longitudinal direction between the two ends of the cavity, which wall can consist in particular of elastic material. In this embodiment, the circumferential side wall of the cavity is designed entirely or at least partially in the manner of a longitudinally expandable sleeve that can be expanded in the longitudinal direction to change the volume of the cavity to increase the length thereof and contracted to reduce the length thereof. The lengthening and shortening is caused by the reciprocal movement with which the second end of the cavity is acted upon by the drive device. With such an embodiment, the desired maximum volume change can be defined in a structurally especially simple and simultaneously effective manner by alternately extending the side wall of the cavity in the region of the length-variable structure essentially in the direction of the longitudinal extension of the cavity defined between its first end and its second end, extended by elongation and shortened by compression.

In a refinement of the exemplary embodiment described above, the expandable wall is designed in such a way that, due to its elasticity, it is still under tension when the distance between the two ends of the cavity is at the minimum value. This results in a restoring force that ensures that the expandable wall returns to its initial state, in which the distance between the two ends of the cavity is at its minimum value. The advantage of this refinement is that the drive device only has to be supplied with corresponding energy to pull the expandable wall apart, while this is not the case for the movement in the opposite direction with a reduction in linear expansion, and the drive device can even be deactivated if necessary.

A preferred alternative embodiment is characterized in that the circumferential, length-variable structure has a zigzag-shaped wall, at least in sections, with circumferential wall sections directed alternately inwards and outwards and connected to one another via a fold line. In this embodiment, the structure is designed in the manner of a bellows, which is alternately pulled apart and compressed like an accordion between the first end and the second end of the cavity. Accordingly, the desired length and thus also the desired variability in length can be obtained depending on the number and/or dimensioning of the width of the individual wall sections. In particular, the circumferential wall section closest to the first end of the cavity should be delimited by a fold line closest to the first end of the cavity, and the circumferential wall section furthest from the first end of the cavity should be delimited by a fold line furthest away from the first end of the cavity, so that each circumferential wall section should be delimited by two fold lines.

In a refinement of this embodiment, the circumferential wall sections have the same width, viewed in the longitudinal direction between the two ends of the cavity.

In a further refinement, the fold lines each span a plane which is preferably essentially at a right angle to the longitudinal extension of the cavity between its two ends and/or to the direction in which the second end of the cavity is moved by the drive device.

A further refinement of the aforementioned embodiment is characterized in that the zigzag-shaped wall has at least two wall sections, of which the first wall section, which is furthest from the first end of the cavity, is directed outwards and the second wall section, which is adjacent to the first wall section, is directed inwards. As a result, it is not the inwardly directed second wall section that is directly acted upon by the reciprocal movement generated by the drive device, but rather the outwardly directed first wall section that is furthest away from the first end of the cavity, and it has been found that such a design works relatively quietly.

A further preferred exemplary embodiment is characterized in that the second end of the cavity is closed by a closure element which is coupled to the drive device and has a material which is less flexible or less resilient, preferably essentially rigid, than the circumferential, length-variable structure. With this embodiment, the reciprocal movement generated by the drive device is transferred to the length-variable structure in a structurally especially simple and simultaneously effective manner. In this embodiment, the second end of the cavity can also be partially or completely formed by the closure element.

In a structurally especially advantageous refinement of this embodiment, the circumferential, length-variable structure and the closure element together form a one-piece component.

An additional refinement of this embodiment is characterized in that the closure element essentially has the shape of a plate, which extends essentially at a right angle to the longitudinal extension of the cavity between its two ends and/or to the direction in which the second end of the cavity is moved by the drive device. With this refinement, any deflection of the second end of the cavity is excluded, as a result of which the loading of the length-variable structure with a reciprocal movement caused by the drive device can be achieved with especially little loss and effectively.

Furthermore, a support structure is preferably provided, which is arranged outside of the cavity on the outside of the side wall, at least in sections, in the region of its circumferential, length-variable structure. Such a support structure prevents, in a structurally especially simple and simultaneously effective manner, an unintentional deflection of the length-variable structure during the compression process and thus also an undesired widening of the cavity in the region of the length-variable structure, as a result of which the desired volume change can be defined and fixed in an especially precise manner.

In a refinement of the aforementioned embodiment, the support structure extends essentially over the entire length of the cavity and/or the support structure is essentially in the shape of a tube, as a result of which the desired support function of the support structure can be implemented in a structurally especially simple and simultaneously effective and reliable manner.

The pressure field should preferably consist of a pattern of relative underpressures and overpressures which are modulated onto a reference pressure, preferably normal pressure. Normal pressure is usually understood to mean the surrounding air pressure. However, if necessary, the reference pressure can also deviate significantly from the surrounding air pressure.

In a refinement of the aforementioned exemplary embodiment, the amount of the relative overpressure, based on the normal pressure, is less than the amount of the relative underpressure, based on the normal pressure, and is in particular no more than 10% of the amount of the relative underpressure, based on the normal pressure. Because it has been found that, under normal conditions of use, if the stimulation device is not subjected to excessive contact pressure when its application opening is placed on the body part to be stimulated, any relative overpressures that may occur are largely eliminated due to the flexibility of the body part to be stimulated because of soft tissue, so that the focus should be on a pressure field that is to be modulated predominantly in the underpressure region because of these rather factual considerations. For this reason, it is alternatively also conceivable that a pressure field from a pattern essentially only arises from relative underpressures, which are then modulated onto the reference pressure.

Preferably, the stimulation device can have no valves, which could otherwise cause unwanted contamination.

As an alternative to this last-mentioned embodiment, an embodiment is also fundamentally conceivable which has a pressure field generating device which has at least one cavity with a first end, which is provided with an application opening for placement on the sensitive body part, wherein the cavity is delimited by a circumferential side wall and a drive device which is designed to bring about a change in the volume of the cavity in such a way that a stimulating pressure field is generated in the application opening and is characterized in that the side wall adjacent to the first end of the cavity is provided with at least one check valve, which is designed to open when an overpressure occurs in the cavity but otherwise is to remain closed.

With this embodiment specified in claim 24, which alternatively also defines a further autonomous and thus independent inventive concept, the previously mentioned effect is taken into account, according to which any relative overpressures that may occur can be eliminated. The check valve, through which the overpressures are eliminated, ensures that the overpressures are essentially completely eliminated and the stimulation device is therefore operated completely in underpressure mode, in particular when the stimulation device is subjected to greater contact pressure when it is placed with its application opening on the body part to be stimulated.

The check valve can preferably be designed as a lip valve and/or, moreover, no further valves can be provided.

In a further preferred embodiment, the pressure field has an essentially sinusoidal-periodic pressure profile, for which purpose the drive device must bring about a regular change in the volume of the cavity, for example with the aid of an assembly comprising a rotary motor and an eccentric mechanism.

A further preferred embodiment is characterized in that the cavity is formed by a single continuous chamber. A one-chamber arrangement realized with this exemplary embodiment is characterized by an especially simple and fluidically effective design. In terms of flow, a one-chamber arrangement is especially interesting because throttling effects, which occur in particular due to constrictions, are avoided. The one-chamber arrangement also has significant advantages with regard to hygiene requirements, since there are no constrictions that would otherwise divide the cavity into two or more chambers, so that no dirt particles can settle. For the same reason, the one-chamber arrangement is also much easier to clean.

In order to achieve a substantially uniform, unimpeded, and therefore effective air flow, it is advantageous if the circumferential side wall that delimits the cavity and connects its two ends to one another is free of points of discontinuity.

To ensure that the air flow rate is essentially unchanged or at least almost the same over the entire length of the cavity, the cross-section of the cavity defined transversely to its length between its two ends should preferably be essentially unchanged or at least almost the same, at least outside the circumferential, length-variable structure. The cross-section is preferably to be understood to mean the cross-sectional shape and/or the cross-sectional area.

Furthermore, the cavity can preferably essentially have the shape of a rotational body with a circular or elliptical cross-section and/or the shape of a continuous tube.

In order to utilize the effect of the air flow or the pressure waves at the application opening as fully as possible, the opening cross-section of the application opening should preferably essentially correspond to the cross-section of the cavity at its first end.

A control device can preferably be provided, which actuates the drive device and has at least one operating means, by means of which the respective modulation of the pressure field can be changed.

The stimulation device should expediently be designed as a hand-held device, preferably operated with a battery.

In the following, preferred exemplary embodiments of the invention will be detailed by means of the accompanying drawings. In the drawings:

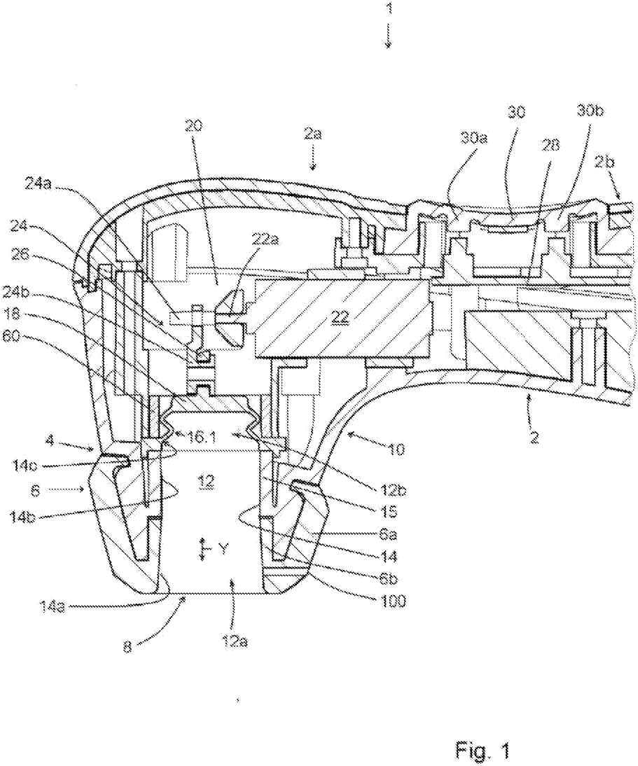

FIG. 1 shows a longitudinal section of a section of the pressure wave massage device in the region of its head according to a preferred first embodiment;

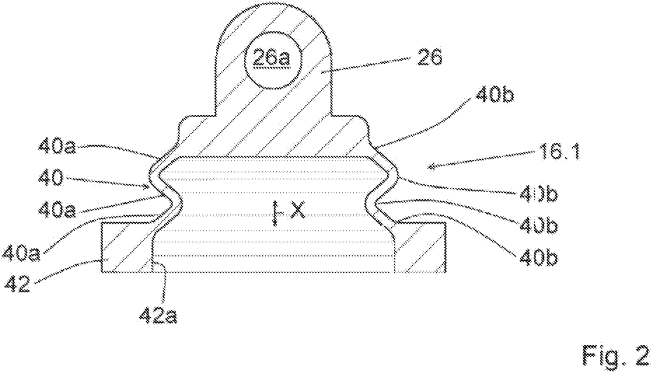

FIG. 2 shows a longitudinal section of an enlarged individual representation of an assembly provided in the pressure wave massage device of FIG. 1 with a connecting element, a length-variable structure, a closure element, and a coupling element;

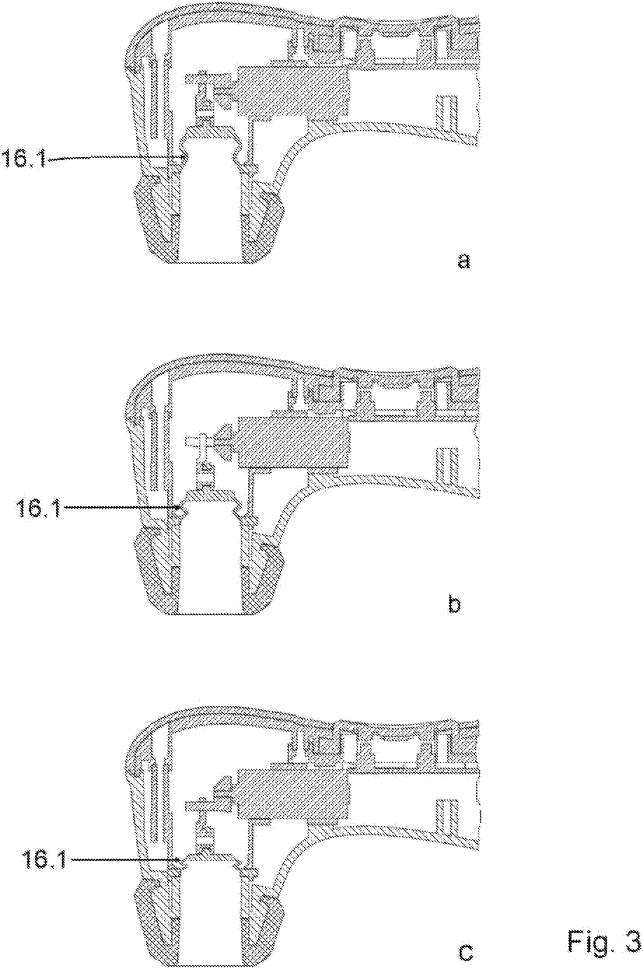

FIGS. 3a to c show the same view as FIG. 1 with different states of movement of the length-variable structure;

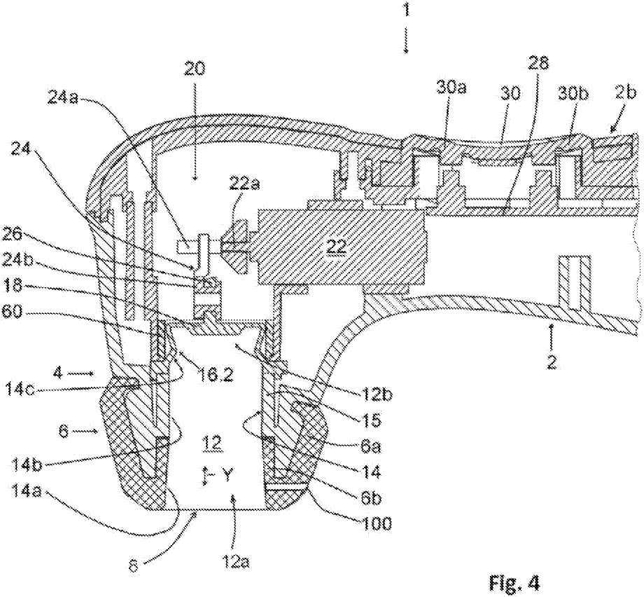

FIG. 4 shows a longitudinal section of a section of the pressure wave massage device in the region of its head according to a preferred second embodiment;

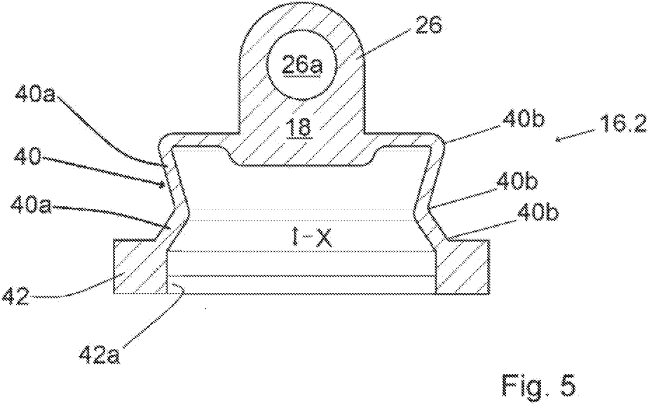

FIG. 5 shows a longitudinal section of an enlarged individual representation of an assembly provided in the pressure wave massage device of FIG. 4 with a connecting element, a length-variable structure, a closure element, and a coupling element;

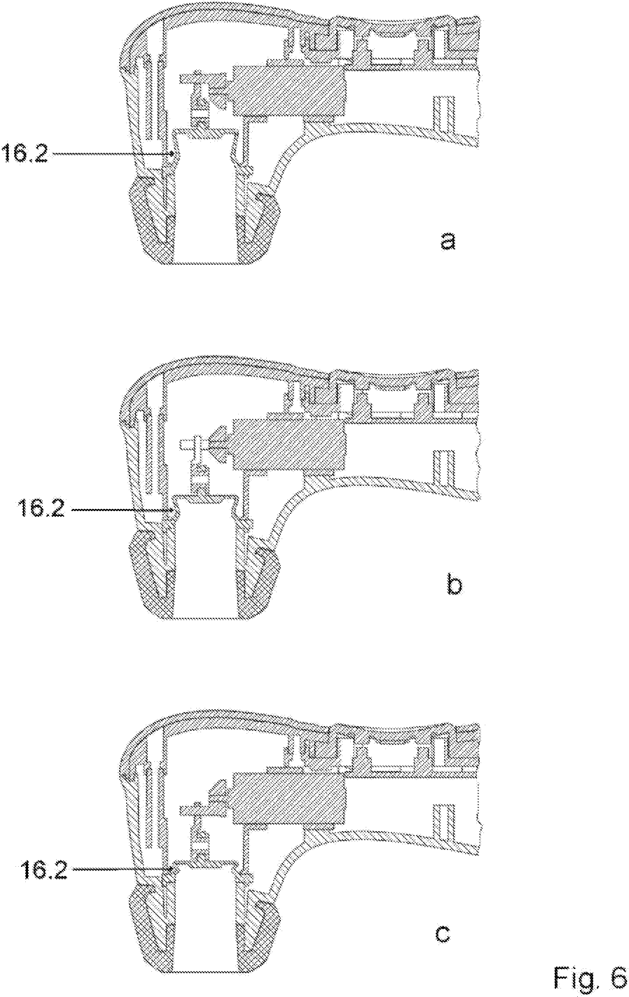

FIGS. 6a to c show the same view as FIG. 4 with different states of movement of the length-variable structure;

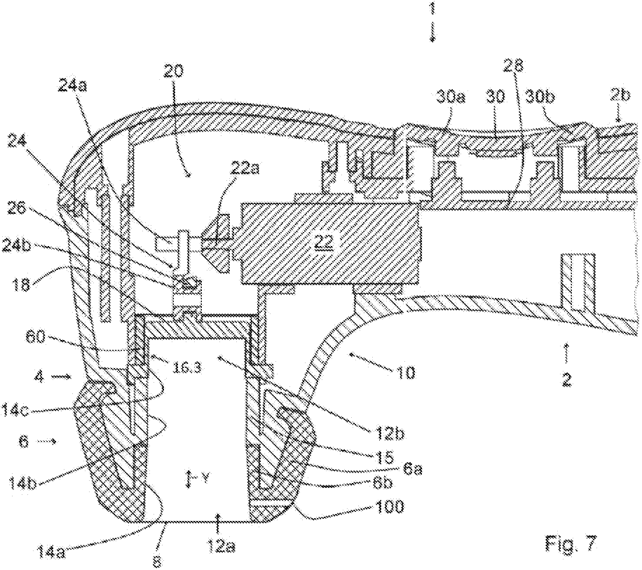

FIG. 7 shows a longitudinal section of a section of the pressure wave massage device in the region of its head according to a preferred third embodiment;

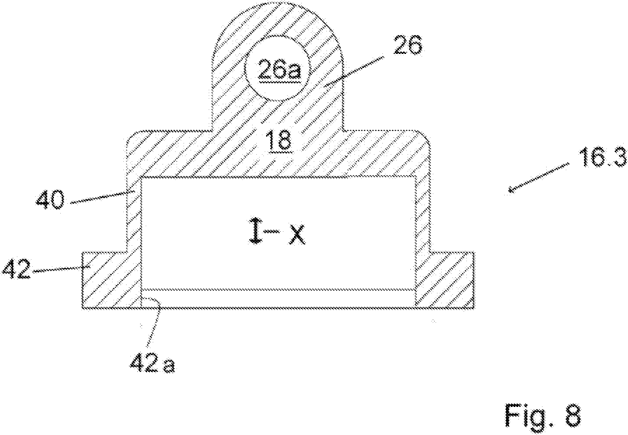

FIG. 8 shows a longitudinal section of an enlarged individual representation of an assembly provided in the pressure wave massage device of FIG. 7 with a connecting element, a length-variable structure, a closure element, and a coupling element;

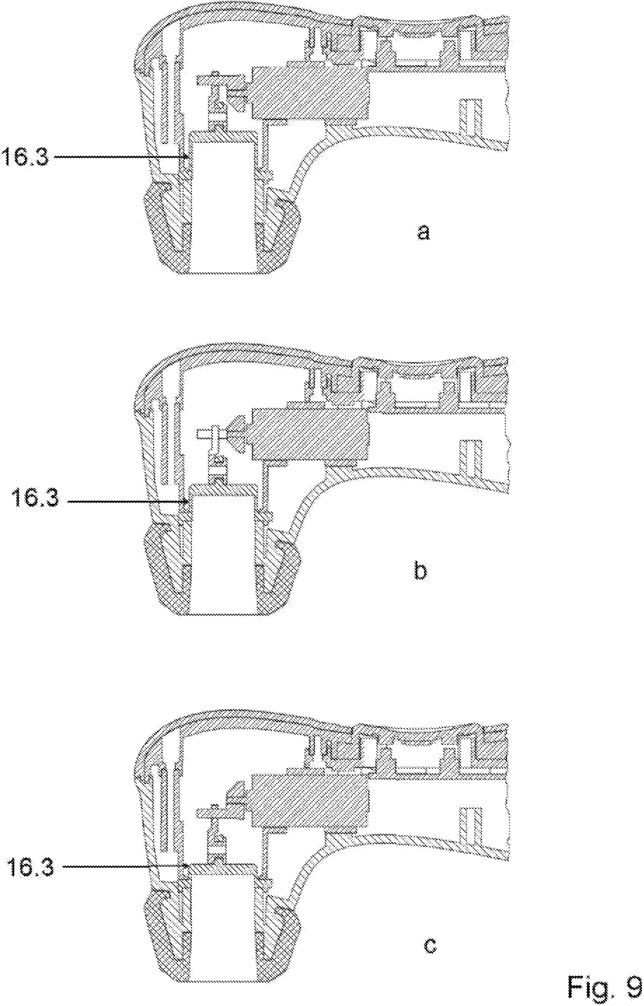

FIGS. 9a to c show the same view as FIG. 7 with different states of movement of the length-variable structure; and

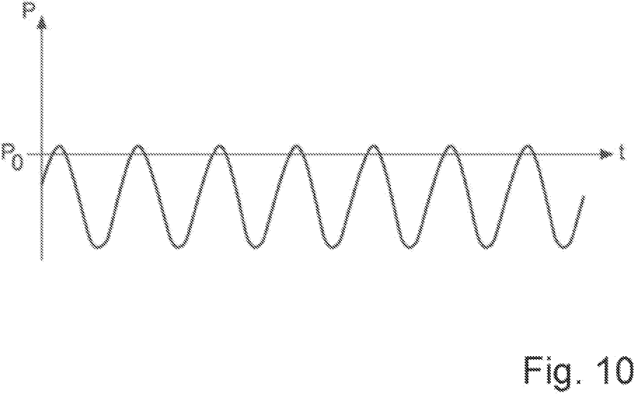

FIG. 10 shows a preferred pressure wave profile generated with the pressure wave massage device according to the previous figures.

In FIG. 1, a pressure wave massage device 1 is shown in sections in the longitudinal section in the region of its head according to a preferred first embodiment. The pressure wave massage device 1 has a housing 2 which, in the exemplary embodiment described here, is divided into three housing sections, namely a first end section, a second end section remote from the first end section, and a middle section lying in between. Only the first end section 2a and partially the middle section 2b of the housing 2 are shown in FIG. 1. As can also be seen in FIG. 1, in the exemplary embodiment shown, the first end section 2a tapers slightly towards the middle section 2b of the housing 2, and the middle section 2b has an elongated shape. The second end section of the housing 2, not shown in FIG. 1, forms a kind of extension of the middle section 2b and essentially continues the elongated shape of the middle section 2b of the housing 2, wherein the width of the second end section increases slightly compared to the middle section 2b of the housing 2. Thus, the housing 2 has an elongated shape in the exemplary embodiment. As can also be seen in FIG. 1, the first end section 2a of the housing 2 is rounded, wherein the second end section of the housing 2 (not shown) is also rounded.

A projection 4 projecting transversely to the longitudinal extension of the housing 2 is formed at the first end section 2a of the housing 2 and, together with the first end section 2a of the housing 2, forms a head of the pressure wave massage device 1, while the second end section of the housing 2 (not shown) is preferably used as a handle to hold the pressure wave massage device 1 during the application to be described in more detail below.

The housing 2 is preferably made of plastic and is composed of two half-shells in the direction of its longitudinal extension, one half-shell of which is provided with the projection 4 mentioned. The two half-shells of the housing 2, which are not identified in more detail in FIG. 1, are preferably glued together; alternatively, however, it is also conceivable, for example, to connect the two half-shells of the housing 2 to one another in a different way, for example with the aid of screws or locking means attached to the inside thereof.

As FIG. 1 also shows, a spout 6 containing an application opening 8 sits on the projection 4. The spout 6 preferably consists of a flexible plastic material such as, in particular, a silicone material. A pressure wave generating device 10 is accommodated in the head of the pressure wave massage device 1 formed by the first end section 2a of the housing 2 and the projection 4, with the aid of which pressure wave generating device a stimulating pressure field is generated in the opening 8. As can be seen in detail in FIG. 1, the pressure field generating device 10 has a cavity 12 with an outer first end 12a and an inner second end 12b opposite the first end 12a and at a distance from the first end 12a, wherein the first end 12a of the cavity 12 opens into the application opening 8 in the spout 6. In the exemplary embodiment shown, the cavity 12 is formed by a single continuous chamber and delimited by an inner or side wall 14 connecting its two ends 12a, 12b to one another.

As can also be seen in FIG. 1, the spout 6 has an outer section 6a, with which it is removably attached to the projection 4, and an inner section 6b, wherein the outer section 6a and the inner section 6b of the spout 6 are connected to each other in the region of the application opening 8. The inner section 6b of the spout 6 is designed in the manner of a sleeve and delimits an outer section of the cavity 12 leading to its outer first end 12a. Thus, the inner wall of the sleeve-like inner section 6b of the spout 6 simultaneously forms an outer section 14a of the inner or side wall 14 of the cavity 12, which outer section leads to the application opening 8. Furthermore, in the exemplary embodiment shown, the cavity 12 is delimited by an inner annular element 15, the inner wall of which simultaneously forms a middle section 14b of the side wall 14 of the cavity 12. The inner annular element 15 is preferably made of a substantially rigid material.

In the exemplary embodiment shown, the end of the annular element 15 adjacent to the second end 12b of the cavity 12 is adjoined by a circumferential structure 16.1, which is designed to be variable in length in the direction of the longitudinal extension of the cavity 12 according to double arrow Y, is arranged on or in the second end 12b of the cavity 12, or forms the second end 12b of the cavity 12, wherein the inner wall thereof simultaneously forms an inner section 14c of the side wall 14. In the exemplary embodiment shown, the length-variable structure 16.1 is designed in the manner of a sleeve and is closed by a closure element 18, which consists of a plate-shaped body that extends approximately at a right angle to the longitudinal direction of the cavity 12. The common arrangement of the structure 16.1 and the closure element 18 is thus designed in the manner of a cap. Accordingly, in the exemplary embodiment shown, the cavity 12, in the form of a continuous single chamber, is composed of the sleeve-shaped inner section 6b of the spout 6, the annular element 15, and the arrangement of the structure 16.1 and the closure element 18. In the exemplary embodiment shown in this case, the arrangement of the spout 6, the annular element 15, and the structure 16.1 is such that the three sections 14a, 14b, and 14c of the side wall 14 are aligned with one another, so that the side wall 14 of the cavity 12 is free of points of discontinuity, wherein, in this context, any inaccuracies in the figures are irrelevant.

In the exemplary embodiment shown, the cavity 12 is preferably essentially in the form of a rotational body with a circular or elliptical cross-section, wherein the cross-section of the cavity 12 defined transversely to its length between its two ends 12a, 12b is essentially constant, at least along the middle section 14b of its side wall 14, and widens only slightly towards the application opening 8 along the outer section 14a of its side wall 14, wherein the opening cross-section of the application opening 8 corresponds to the cross-section of the cavity 12, at least at its first end 12a.

Alternatively, it is also conceivable to design the outer section 14a of the side wall 14 formed by the sleeve-shaped inner section 6b of the spout 6 so that it is exactly aligned with the middle section 14b of the side wall 14 formed by the inner wall of the annular element 15, so that the cross-section of the cavity 12 in the region of the outer section 14a of the side wall 14 is equal to the cross-section in the region of the middle section 14b of the side wall 14. Furthermore, it is alternatively also conceivable to provide the cavity 12 with an angular, for example square, cross-section instead of a round cross-section. Thus, in the exemplary embodiment shown, the cavity 12 has the shape of a continuous tube which is oriented approximately transversely to the longitudinal extension of the housing 2 in the direction of its length.

The length-variable structure 16.1 is designed to be variable in length in such a way that the distance between the closure element 18 and thus also the second end 12b of the cavity 12 can be varied between a minimum value and a maximum value. For this purpose, the closure element 18 is driven by a drive device 20 which has a drive motor 22 and is designed such that the rotational movement of the output shaft 22a of the drive motor 22 is converted into a reciprocal longitudinal movement. For this purpose, in the exemplary embodiment shown, the drive device 20 contains an eccentric assembly 24, which has an eccentric pin 24a arranged on the output shaft 22a of the drive motor 22, but at a radial distance from the axis of rotation of the output shaft 22a, and a connecting rod 24b, on which the eccentric pin 24a is movably mounted. At its end adjacent to the eccentric pin 24a, the connecting rod 24b is provided with a bore, not shown in more detail in FIG. 1, through which the eccentric pin 24a is loosely inserted. At the opposite end, the connecting rod 24b is coupled to a coupling element 26 which is arranged on the closure element 18. Thus, the rotation of the output shaft 22a of the drive motor 22 is converted into a reciprocal longitudinal movement of the connecting rod 24b, as a result of which the closure element 18 is caused to move alternately in the direction of the application opening 8 and in the direction opposite thereto.

The reciprocal movement of the closure element 18 leads to a corresponding loading of the length-variable structure 16.1, which is alternately pulled apart and thus lengthened and compressed and thus shortened in accordance with the reciprocal movement of the closure element 18. This causes the volume of the cavity 12 to change between a minimum volume and a maximum volume, so that underpressures and overpressures alternate in the cavity 12 and thus a corresponding stimulating pressure field is generated in the application opening 8. In this context, it should also be noted that, instead of using a rotary motor and an eccentric assembly, other types of drives are essentially also conceivable in order to subject the closure element 18 and thus the length-variable structure 16.1 to a reciprocal movement, which can also be done, for example, electromagnetically, piezoelectrically, pneumatically, or hydraulically.

In the exemplary embodiment shown, the drive motor 22 is an electric motor that is connected to an electronic control circuit board 28 that actuates the drive motor 22. A battery, not shown in FIG. 1, is connected to the control circuit board 28 and supplies the drive motor 22 and the control circuit board 28 with the necessary electrical energy. This battery can either be a non-rechargeable battery or a rechargeable battery. While the drive motor 22 is located in the first end section 2a of the housing 2 in the exemplary embodiment shown, the battery, not shown in FIG. 1, is arranged in the second end section of the housing 2, also not shown in FIG. 1, whereby the housing 2 is well balanced when the pressure wave massage device 1 is held in the user’s hand.

As can also be seen schematically in FIG. 1, in the exemplary embodiment shown, an externally accessible rocker switch 30 is arranged in the connection region between the first end section 2a and the middle section 2b of the housing 2, with the two end sections 30a, 30b of which certain switching operations can be carried out. For example, one end section 30a of the switch 30 can be provided for switching the pressure wave massage device 1 on and off, and the other end section 30b can be provided for setting different operating states.

In addition to controlling the drive motor 22, the electronic control circuit board 28 also handles the charging management of the battery (not shown in FIG. 1) in the exemplary embodiment shown. For this purpose, the control circuit board 28 is connected to charging contacts, also not shown in FIG. 1, which are accessible from the outside and are preferably arranged on the end face of the second end section of the housing 2, also not shown in FIG. 1. An external charger (also not shown in FIG. 1) can be connected to these connection contacts via a plug with magnetic plug-in contacts, which can be brought into contact with the connection contacts to produce an electrical connection due to magnetic forces.

FIG. 2 shows a longitudinal section in an enlarged individual view of an assembly containing the structure 16.1 from the pressure wave massage device 1 shown in FIG. 1. As can be seen in FIG. 2, the structure 16.1 has a zigzag-shaped wall 40 with circumferential wall sections 40a directed inwards and outwards in an alternating manner. The wall sections 40a are each connected to one another via a circumferential fold line 40b. Furthermore, the length-variable structure 16.1 has a corresponding annular circumferential connecting element 42 at its end closest to the first end 12a of the cavity 12, at which connecting element the zigzag-shaped wall 40 ends and is fixed there. This connecting element 42 in turn is used for the, in particular fixed, arrangement of the length-variable structure 16.1 on the annular element 15 and is designed in such a way that the inner wall 42a of the connecting element 42 can be connected to the inner wall of the annular element 15 and, accordingly, aligns with the middle section 14b of the side wall 14 of the cavity 12. The wall 40 and the inner wall 42a of the connecting element 42 together form the aforementioned inner section 14c of the side wall 14 of the cavity 12.

In the exemplary embodiment shown, the first wall section 40a, which is adjacent to the closure element 18 and thus the closest, is delimited by a fold line 40b provided between this wall section 40a and the closure element 18; and the third wall section 40a, which is adjacent to the connecting element 42, is delimited by a fold line 40b provided between this third wall section 40a and the connecting element 42; and the intermediate second wall section 40a is delimited by two fold lines 40b, of which one fold line 40b establishes the connection to the third wall section 40a, which is adjacent to the connecting element 42, and the other fold line 40b establishes the connection to the first wall section 40a, which is adjacent to the closure element 18. As FIG. 2 also shows, in the exemplary embodiment shown, the first wall section 40a, which is closest to the closure element 18 and is therefore adjacent thereto, is directed outwards and the second wall section 40a, which is adjacent to this first wall section 40a, is directed inwards. In deviation from the illustration in FIG. 2, the third wall section 40a, which is adjacent to the connecting element 42, can also be omitted, so that, in this alternative variant, the zigzag-shaped wall 40 with the first and second wall sections 40a only has two wall sections, which are directed outwards as relates to its common fold line.

As can also be seen from FIG. 2, in the exemplary embodiment shown, the circumferential wall sections 40a have essentially the same width between the two fold lines 40b delimiting them. In addition, in the exemplary embodiment shown, the fold lines 40b each span a plane which extends essentially at a right angle to the direction of reciprocal movement of the closure element 18, wherein the direction of reciprocal movement is identified by double arrow X in FIG. 2.

In the exemplary embodiment shown, the closure element 18 forms a plate-shaped body which extends essentially parallel to the previously mentioned planes spanned by the fold lines 40b and essentially at a right angle to the direction of reciprocal movement according to the double arrow X, with which reciprocal movement the closure element 18 and thus the length-variable structure 16.1 can be acted upon by the connecting rod 24b. As can also be seen in FIG. 2, the coupling element 26 arranged on the closure element 18 is provided with a bore 26a, through which a pin (not shown in the figures) is inserted, which extends through a complementary bore in the connecting rod 24b, whereby the connecting rod 24b is coupled to the coupling element 26.

In order to achieve the desired change in length, the wall 40 is provided with flexible or elastic material, at least in the region of the fold line 40b. For reasons of a simpler design, the entire wall 40 can preferably consist of flexible or elastic material. Silicone is preferably considered as such a material. In contrast, both the closure element 18 and the connecting element 42 consist of a less flexible or less yielding material, which is preferably essentially rigid, and which is in particular a suitable plastic. In the exemplary embodiment illustrated in FIG. 2, the coupling element 26, the closure element 18, the wall 40, and the connecting element 42 together form a one-piece component which, for the sake of simplicity, should be made of the same material; in this case, the flexibility desired for the wall 40, at least in sections, is achieved in that the wall thickness is significantly less than in the case of the closure element 18 and the connection element 42, as can be seen in FIG. 2. In view of the different properties mentioned above, it is alternatively also conceivable to provide the closure element 18 with the coupling element 26, the wall 40, and the connecting element 42 as separate components, which are then to be attached to one another accordingly.

The length-variable structure 16.1 is shown in three different operating states in FIGS. 3a to c. FIGS. 3a to c are basically the same longitudinal sectional view as in FIG. 1, but, for reasons of clarity, only the length-variable structure is identified by the reference number; however, in contrast to FIG. 1, no further reference numbers are given. FIG. 3b shows the length-variable structure 16.1 in a middle position similar to FIG. 1. FIG. 3a shows the length-variable structure 16.1 in a completely pulled-apart position, in which the closure element 18 is arranged a maximum distance from the application opening 8. In contrast, FIG. 3c shows the length-variable structure 16.1 in a fully compressed position, in which the closure element 18 is arranged a minimum distance from the application opening 8. According to the reciprocal movement of the closure element 18 generated by the drive device 20, the length-variable structure 16.1 is alternately pulled apart or lengthened in the manner of an accordion and thus brought into the state shown in FIG. 3a and compressed or shortened again and brought into the state shown in FIG. 3c.

As can also be seen in FIGS. 3a to 3c, the shape of the wall 40 remains the same, apart from being expanded due to the pulling apart of the length-variable structure 16.1 into the position shown in FIG. 3a and being shortened due to the compression of the length-variable structure 16.1 into the position shown in FIG. 3c; otherwise, it remains basically essentially unchanged. Furthermore, during the movement of the length-variable structure 16.1, the volume in the section of the cavity 12 delimited by the inner wall of the annular element 15 and by the inner section 6b of the spout 6 remains essentially unchanged. Although preferably, as mentioned above, the spout 6 consists of a flexible plastic material, the flexibility of such a material should be selected in such a way that the degree of deformation is kept within relatively small limits in order to leave the volume of the cavity 12 essentially unaffected in the region of the spout 6.

In the exemplary embodiment shown, the closure element 18 extends essentially parallel to the plane spanned by the application opening 8 and is subjected to a reciprocal movement essentially at a right angle thereto, which reciprocal movement is oriented essentially in the longitudinal direction of the cavity 12 according to the double arrow Y shown in FIG. 1. Thus, due to the reciprocal movement of the closure element 18, its distance from the application opening 8 and thus from the first end 12a of the cavity 12 changes by essentially the same amount at any given point. Alternatively, it is also conceivable to design and/or to orientate the length-variable structure 16.1 such that, during the reciprocal movement of the closure element 18, the distance at different points between the closure element 18 and the application opening 8 and thus the first end 12a of the cavity 12 changes by a different amount.

A second embodiment of the pressure wave massage device 1 is shown in FIGS. 4 to 6, which differs from the first embodiment according to FIGS. 1 to 3 only in the configuration of the length-variable structure. Therefore, for the second embodiment, the length-variable structure is identified by reference numeral 16.2. Apart from the use of the differently designed length-variable structure 16.2, the second embodiment has no other differences from the first embodiment, so that the description of the first embodiment also fully applies to the second embodiment, which also applies analogously to FIGS. 4 to 6 in relation to the FIGS. 1 to 3, and therefore, to avoid repetition, reference is made to the description of the first embodiment.

The length-variable structure 16.2 according to the second embodiment differs from the length-variable structure 16.1 according to the first embodiment only in that only two wall sections 40a are provided, both of which are directed inwards.

A third embodiment of the pressure wave massage device 1 is shown in FIGS. 7 to 9, which differs from the first embodiment according to FIGS. 1 to 3 only in the configuration of the length-variable structure. Therefore, for the third embodiment, the length-variable structure is identified by reference numeral 16.3. Apart from the use of the differently designed length-variable structure 16.3, the third embodiment has no other differences from the first embodiment, so that the description of the first embodiment also fully applies to the third embodiment, which also applies analogously to FIGS. 7 to 9 in relation to the FIGS. 1 to 3, and therefore, to avoid repetition, reference is made to the description of the first embodiment.

Specifically, the length-variable structure 16.3 according to the third embodiment differs from length-variable structures 16.1 and 16.2 according to the first and second embodiments in that the wall 40 is not designed in a zigzag shape, but essentially extends straight, parallel to, or in the direction of the reciprocal movement indicated by double arrow X, and is designed to be expandable. In this embodiment, the circumferential wall 40 thus forms a longitudinally expandable sleeve which, in order to change the volume of the cavity 12, can be expanded in the longitudinal direction, which increases its length to the state shown in FIG. 9a, and can be contracted in the longitudinal direction, which reduces its length to the state shown in FIG. 9c. The lengthening and shortening of the wall 40 and thus also of length-variable structure 16.3 is caused by the reciprocal movement according to double arrow X, with which reciprocal movement the closure element 18 is acted upon.

The expandable wall 40 of the length-variable structure 16.3 is preferably made of elastic material and is designed in such a way that, due to its elasticity, it is still under tension when the distance between the closure element 18 and the connecting element 42 is at its minimum value. This results in a restoring force that ensures that the expandable wall 40 returns to its initial state, in which the distance between the second end 12b and the first end 12a of the cavity 12 assumes the minimum value according to the state shown in FIG. 3c. The advantage of this refinement is that the drive motor 22 only has to be supplied with the appropriate energy for pulling the expandable wall 40 apart, while this is not the case for the movement in the opposite direction with a reduction in linear expansion and, even if required, the drive motor 22 can be disabled by the control circuitry on the control circuit board 28.

As can also be seen from FIGS. 1, 4, and 7, in the exemplary embodiment shown there, a support structure 60 is provided outside of length-variable structure 16.1, 16.2, or 16.3, with it being possible to place the inside thereof in contact with the outside of length-variable structure 16.1, 16.2, or 16.3. The support structure 60 thus prevents an unintentional yielding of length-variable structure 16.1, 16.2, or 16.3 during the compression process and thus also an undesired widening of the cavity 12 in the region of the length-variable structure. Length-variable structure 16.1, 16.2, or 16.3 is preferably completely surrounded by the support structure 60. For this purpose, the support structure is preferably designed as a tube which is open at the two end faces and whose cross-section is approximately complementary to the cross-section of length-variable structure 16.1, 16.2, or 16.3. The support structure 60 preferably extends in the direction of the longitudinal extension of the cavity 12 at least over a length within which length-variable structure 16.1, 16.2, or 16.3 performs its reciprocal movement between a minimum value and a maximum value. For the sake of completeness, it should also be noted in this context that the support structure is not shown in FIGS. 3, 6, or 9 for reasons of better clarity.

The pressure wave massage device 1 described according to the embodiments shown in FIGS. 1, 4, and 7 is designed as a hand-held device and for use with the spout 6 placed on the body part to be stimulated (not shown in the figures) so that it is essentially surrounded by the spout 6 in the region of the application opening 8. During operation, the body part to be stimulated is then subjected to alternating different air pressures and/or air flows due to the reciprocal movement of length-variable structure 16.1, 16.2, or 16.3. If no excessive contact pressure has been applied after the spout 6 has been placed on the body part to be stimulated, any relative overpressures that may have developed during the respective movement of the closure element 18 can be discharged in the direction of the application opening 8 and the resulting shortening of the length-variable structure 47 can result due to compression, essentially resulting in the pattern shown in FIG. 10 of a modulated relative underpressure compared to the normal reference pressure P₀. Nevertheless, as can be seen from the pressure curve in FIG. 10, maximum relative overpressures can occur compared to the reference pressure P₀, which, however, can be significantly lower than the minimum of the relative underpressure. The amount of the relative overpressure, based on the reference pressure P₀, is usually no more than 10% of the amount of the relative underpressure, especially if the reference pressure is normal air pressure or ambient air pressure, but the relative overpressure can also be higher depending on the operating state and application. Alternatively, however, it is also quite conceivable that the pressure field consists only of a pattern of relative underpressures or relative overpressures, which is modulated onto the reference pressure P₀. The sinusoidal-periodic pressure curve shown in FIG. 10 results in particular when using a rotary motor with an eccentric assembly.

A distinction is made between sealed operation, open operation, and so-called half-open operation.

During sealed operation, the spout 6 is placed on the body part to be stimulated in such a way that air exchange with the environment does not take place. In this operating state, the movement of length-variable structure 16.1, 16.2, or 16.3 causes pressure waves that change over time, preferably periodically, and that act in the entire cavity 12. The pressure waves are essentially isotropic and thus also affect the body part to be stimulated. In contrast, there is essentially no air flow.

The open operation is characterized in that an exchange of air takes place between the cavity 12 and the environment. In this operating state, the spout 6 is placed on the body part to be stimulated in such a way that the application opening 8 only partially encloses the body part to be stimulated and at least one gap-shaped intermediate space remains free between at least one section of the application opening 8 and at least one section of the body part to be stimulated, whereby air can escape from the cavity 12 into the environment. In this operating state, air can also be suctioned from the environment into the cavity 12, so that, in this case, there is a regular exchange of air and the air is moved reciprocally within the cavity 12 in the direction of the longitudinal extension of the cavity 12, as is indicated by double arrow Y in FIGS. 1, 4, and 7. In open operation, the overpressures and underpressures are significantly lower than in sealed operation.

Finally, a so-called half-open operation is also conceivable, in which, after the spout 6 has initially been completely placed on the body part to be stimulated, no excessively strong contact pressures are exerted, so that, due to a flexibility of the body part to be stimulated, as already mentioned, any relative overpressures can be eliminated; whereas, after an underpressure has developed in the cavity 12 upon movement of length-variable structure 16.1, 16.2, or 16.3 in the direction away from the application opening 8, the sections of the body part to be stimulated that have been opened by the overpressure are pulled back to the application opening 8 due to the suction effect thereby formed, and thus the body part to be stimulated completely closes the application opening 8 again. In this case, the body part to be stimulated acts in the manner of a check valve. In half-open operation, the overpressures are considerably lower than in sealed operation, while the underpressures can be of a similar order of magnitude as in sealed operation. Experience has shown that half-open operation is the most common application.

Since, as already described above, the cross-section of the cavity 12 remains essentially almost the same, at least in the region of the outer section 14a and the middle section 14b of the side wall 14, this means that, in open operation, the air flow rate in both directions is essentially constant, at least there; and in half-open operation, this means that the air flow rate also remains essentially the same, at last there, in the direction of the application opening 8. In this way, an especially effective air flow can be generated in these operating states for effective stimulation of the body part to be stimulated with relatively little energy consumption by the drive motor 22.

The previously mentioned control circuit board 28 preferably has a memory, also not shown in the figures, in which different modulation patterns are stored for the generation of pressure waves and the vibration. A desired modulation pattern can then be selected for operation by appropriate operation of the rocker switch 30.

As can also be seen in FIGS. 1, 4, and 7, in the exemplary embodiments illustrated there, the spout 6 is provided with a valve adjacent to the application opening 8, which valve is designed as a check valve and is shown schematically in FIGS. 1, 4, and 7 and is given the reference numeral 100. In contrast, such a check valve is not shown in FIGS. 3, 6, and 9 for reasons of clarity. With the optional use of such a check valve, the previously described effect is taken into account, according to which any relative overpressures that may occur can be eliminated. For an essentially complete elimination of the overpressures from the cavity 12 and thus an operation of the pressure wave massage device 1 completely in underpressure mode, in particular if the pressure wave massage device 1 is subjected to stronger contact pressures when it is placed with its application opening 8 on the body part to be stimulated (not shown in FIG. 1), then the check valve 100 ensures that the overpressures or at least the remaining overpressures are eliminated. The check valve 100 is preferably designed as a lip valve.

Irrespective of the optional use of the check valve 100 described above, no further valves should preferably be provided.

1. A device for stimulating sensitive body parts, the device comprising:
a pressure field generating device having at least one cavity with a first end and a second end remote from the first end, wherein the cavity is delimited by a circumferential side wall connecting the first end and the second end to one another, the first end of the cavity having an application opening for placement on the sensitive body part; and
a drive device operable to change a volume of the cavity to generate a stimulating pressure field in the application opening,
wherein the cavity is closed on the second end, wherein the second end is moved by the drive device alternately in a first direction of the application opening and in a second direction opposite thereto,
wherein at least one section of the circumferential side wall has an essentially continuously circumferential, length-variable structure wherein a first distance at any given point between the second end and the first end of the cavity is variable between a minimum value and a maximum value, respectively.

2. The device according to claim 1, wherein a shape of the circumferential side wall remains essentially unchanged, other than during an elongation when the distance between the second end and the first end changes from the minimum value to the maximum value and a compression when the distance between the second end and the first end changes from the maximum value to the minimum value.

3. The device according to claim 1, wherein essentially an entire length of the circumferential side wall is formed by the circumferential, length-variable structure.

4. The device according to claim 1, wherein the circumferential, length-variable structure is arranged at a second distance from the first end of the cavity, and the circumferential side wall has a substantially pressure-resistant and tensile-resistant rigid section between the circumferential, length-variable structure and the first end of the cavity.

5. The device according to claim 1, wherein the circumferential, length-variable structure is arranged at a second distance from the second end of the cavity, and the circumferential side wall has a substantially pressure-resistant and tensile-resistant rigid section between the circumferential, length-variable structure and the second end of the cavity.

6. The device according to claim 1, wherein the circumferential, length-variable structure is one of arranged adjacent to the second end of the cavity or adjoins the second end of the cavity.

7. The device according to claim 1, wherein the circumferential, length-variable structure has an expandable wall expandable at least in sections, in a longitudinal direction between the first end and the second end.

8. The device according to claim 7, wherein the expandable wall comprises elastic material.

9. The device according to claim 8, wherein the expandable wall remains under tension when the first distance between the first end and the second end is at the minimum value.

10. The device according to claim 1, wherein the circumferential, length-variable structure has a zigzag-shaped wall, at least in sections, with circumferential wall sections directed alternately inwards and outwards and connected to one another via respective fold lines.

11. The device according to claim 10, wherein the circumferential wall sections have essentially a same width between two fold lines delimiting them.

12. The device according to claim 10, wherein the fold lines each span a plane which extends at least one of essentially at a right angle to a longitudinal extension of the cavity between the first end and the second end or essentially to the first direction or second direction in which the second end is moved by the drive device.

13. The device according to claim 10, wherein the zigzag-shaped wall has at least two wall sections, wherein a first wall section furthest from the first end of the cavity, is directed outwards and a second wall section adjacent to the first wall section is directed inwards.

14. The device according to claim 10, wherein the second end is closed by a closure element coupled to the drive device and comprises a material which is one of less flexible, less resilient, or essentially rigid compared to the circumferential, length-variable structure.

15. The device according to claim 14, wherein the circumferential, length-variable structure and the closure element form a one-piece component.

16. The device according to claim 14, wherein the closure element is plate shaped and, one of extends essentially at a right angle to a longitudinal extension of the cavity between the first end and the second end or extends to the first direction or second direction in which the second end of the cavity is moved by the drive device.

17. The device according to claim 14, further comprising a support structure arranged outside the cavity on an outside of the circumferential side wall at least in sections, in a region of circumferential, length-variable structure.

18. The device according to claim 17, wherein the support structure extends essentially over a full length of the cavity.

19. The device according to claim 17, wherein the support structure is essentially tube shaped.

20. The device according to claim 17, wherein the pressure field comprises a pattern of relative underpressures and overpressures which are modulated onto a reference pressure.

21. The device according to claim 20, wherein an amount of the relative overpressure, relative to a normal pressure, is less than an amount of the relative underpressure, relative to the normal pressure.

22. The device according to claim 21, wherein the amount of the relative overpressure, relative to the normal pressure, is no more than 10% of the amount of the relative underpressure, relative to the normal pressure.

23. The device according to claim 21, being valve free.

24. A device for stimulating sensitive body parts, the device comprising:
a pressure field generating device having at least one cavity with a first end having an application opening, wherein the cavity is delimited by a circumferential side wall; and
a drive device operable to change a volume of the cavity to generate a stimulating pressure field in the application opening, wherein the circumferential side wall adjacent to the first end of the cavity comprises a check valve, the check valve configured to open when an overpressure develops in the cavity.

25. The device according to claim 24, wherein the check valve is a lip valve.

26. The device according to claim 24, having no other valves other than the check valve.

27. The device according to claim 24, wherein the pressure field comprises a pattern of relative underpressures which are modulated onto a reference pressure.

28. The device according to claim 24, wherein the pressure field has an essentially sinusoidal-periodic pressure curve.

29. The device according to claim 24, wherein the cavity is a single continuous chamber.

30. The device according to claim 24, wherein at least one section of the circumferential side wall has an essentially continuously circumferential, length-variable structure such that a distance at any given point between a second end of the cavity and the first end is variable between a minimum value and a maximum value respectively, wherein the circumferential side wall delimiting the cavity and connecting the first end and the second end to one another is free of points of discontinuity for substantially uniform, unimpeded air flow, at least outside the circumferential, length-variable structure.

31. The device according to claim 24, wherein at least one section of the circumferential side wall has an essentially continuously circumferential, length-variable structure such that a distance at any given point between a second end of the cavity and the first end is variable between a minimum value and a maximum value respectively, wherein a cross-section of the cavity defined transversely to its length between the first end and the second end is essentially unchanged, at least outside the circumferential, length-variable structure, so that an air flow rate is essentially unchanged in a direction of the longitudinal extension of the cavity, at least outside the circumferential, length-variable structure.

32. The device according to claim 24, wherein the cavity has an essentially rotational body with one of a circular or elliptical cross-section.

33. The device according to claim 24, wherein the cavity has a continuous tube shape.

34. The device according to claim 24, wherein an opening cross-section of the application opening essentially corresponds to the cross-section of the cavity at the first end.

35. The device according to claim 24, further comprising a control device configured to actuate the drive device and having at least one operating means to change a respective modulation of the pressure field.

36. The device according to claim 24, wherein the device is a hand-held device operated with a battery.
